(19) United States
(12) Patent Application Publication
(10) Pub. No.: US 2008/0013809 A1
(43) Pub. Date: Jan. 17, 2008

(54) Methods and apparatuses for registration in image guided surgery

(75) Inventors: Chuanggui Zhu, Singapore (SG); Xiaohong Liang, Singapore (SG)

Correspondence Address: VOLUME INTERACTIONS PTE LTD, INTELLECTUAL PROPERTY DEPT., 7905 FULLER ROAD, EDEN PRAIRIE, MN, 55344, US

(73) Assignee: Bracco Imaging, SPA

(21) Appl. No.: 11/487,099

(22) Filed: Jul. 14, 2006

(51) Int. Cl. G06K 9/00

(52) U.S. Cl. 382/128; 382/115

(57) ABSTRACT

Methods and apparatuses for reuse registration data in image guided surgery. One embodiment includes: receiving input data to register image data with a patient; generating registration data based on the input data; and recording the registration data. Another embodiment includes: performing a search for registration data for registering image data with a patient in an image guided process; response to a determination to perform registration after the search, receiving input data to register the image data with the patient, generating registration data based on the input data, and recording the registration data; and response to a determination to use the registration data found in the search, using the registration data found in the search in the image guided process.

### TECHNOLOGY FIELD

At least some embodiments of the present disclosure relate to image guided surgery in general and, particularly but not limited to, registration process for image guided surgery.

### BACKGROUND

Image guidance systems have been widely adopted in neurosurgery and have been proven to increase the accuracy and reduce the invasiveness of a wide range of surgical procedures. Typical image guided surgical systems (or “navigation systems”) are based on a series of images constructed from pre-operative imaging data that is gathered before the surgical operation, such as Magnetic Resonance Imaging (MRI) images, Computed Tomography (CT) images, X-ray images, ultrasound images and/or the like. The pre-operative images are typically registered in relation with the patient in the physical world by means of an optical tracking system to provide guidance during the surgical operation.

For example, to register the patient in the operating room with the pre-operative image data, markers are typically placed on the skin of the patient so that their positions as determined using the optical tracking system can be correlated with their counterparts on the imaging data.

By linking the preoperative imaging data with the actual surgical space, navigation systems can provide the surgeon with valuable information about the localization of a tool, which is tracked by the tracking system, in relation to the surrounding structures.

The registration process in image guided surgery typically involves generating a transformation matrix, which correlates the coordinate system of the image data with a coordinate system of the tracking system. Such a transformation matrix can be generated, for example, by identifying a set of feature points (such as implanted fiducial markers, anatomical landmarks, or the like) on or in the patient in the image data in the coordinate system of the image data, identifying the corresponding feature points on the patient on the operation table using a tracked tool (for example, a location-tracked probe) in a coordinate system of the tracking system, and determining the transformation matrix which provides the best match between the feature points identified in the coordinate system of the image data and the corresponding feature points identified in the coordinate system of the tracking system.

Registration of image data with a patient is typically performed before the surgery. In many cases, the time window for performing the registration operation is within a specific stage of an image guided surgical process, such as before the surface of the patient is cut in neurosurgery, or before the bone is cut in orthopedic surgery.

### SUMMARY OF THE DESCRIPTION

Methods and apparatuses for reuse registration data in image guided surgery are described herein. Some embodiments are summarized in this section.

One embodiment includes: receiving input data to register image data with a patient; generating registration data based on the input data; and recording the registration data. In one embodiment, the registration data is the data generated from a registration process; the registration data not only maps the image data of a patient to the patient, but also defines the patient's position and orientation to a physical device, such as a tracking system or a reference system.

Another embodiment includes: performing a search for registration data (e.g., looking for registration data stored in a file with a specific path and file name in a file system) for registering image data with a patient in an image guided process; response to a determination to perform registration after the search, receiving input data to register the image data with the patient, generating registration data based on the input data, and recording the registration data; and response to a determination to use the registration data found in the search, using the registration data found in the search in the image guided process.

The present disclosure includes methods and apparatus which perform these methods, including data processing systems which perform these methods and computer readable media which when executed on data processing systems cause the systems to perform these methods.

Other features will be apparent from the accompanying drawings and from the detailed description which follows.

### BRIEF DESCRIPTION OF THE DRAWINGS

The disclosure is illustrated by way of example and not limitation in the figures of the accompanying drawings in which like references indicate similar elements.

FIG. 1 illustrates an image guided surgery system according to one embodiment.

FIG. 2 illustrates another image guided surgery system according to one embodiment.

FIG. 3 illustrates a flow chart example of a method for image to patient registration according to one embodiment.

FIG. 4 illustrates a registration file in an image guided surgery system according to one embodiment.

FIG. 5 illustrates a graphic user interface in an image guided surgery system according to one embodiment.

FIG. 6 shows a block diagram example of a data processing system for image guided surgery according to one embodiment.

### DETAILED DESCRIPTION

The following description and drawings are illustrative of the disclosure and are not to be construed as limiting the disclosure. Numerous specific details are described to provide a thorough understanding. However, in certain instances, well known or conventional details are not described in order to avoid obscuring the description. References to one or an embodiment in the present disclosure can be, but not necessarily are, references to the same embodiment; and, such references mean at least one.

At least some embodiments seek to improve the registration process in image guided surgery. In one embodiment, registration data is stored or recorded to allow the reuse of the registration data, after an image guided process is restarted.

For example, after software or hardware breakdown, power loss or the like, an image guided process can be restarted in a computer without having to perform a new registration procedure from scratch. At least a portion of the registration operations that are typically performed to spatially correlate the image data and the positions relative to the patient in the operating room can be eliminated through the reuse of recorded registration data.

In one embodiment, a spatial relation between the image data and a reference system that has a fixed or known spatial relation with the patient is obtained in a registration procedure and recorded. Data representing the spatial relation can be recorded in a non-volatile memory, such as a hard drive, a flash memory or a floppy disk, or stored on a networked server, or in a database. During the image guided surgery, a tracking system is used to determine the location of the reference system in the operating room, in real time, or periodically, or when requested by a user. Using the recorded spatial relation and the tracked location of the reference system, locations determined by the tracking system, such as the position of a probe, can be correlated with the image data, based on the tracking of both the reference system and the probe. When the computer process for image based guidance is restarted, the computer process can load the registration data without having to require the user to perform some of the registration operations.

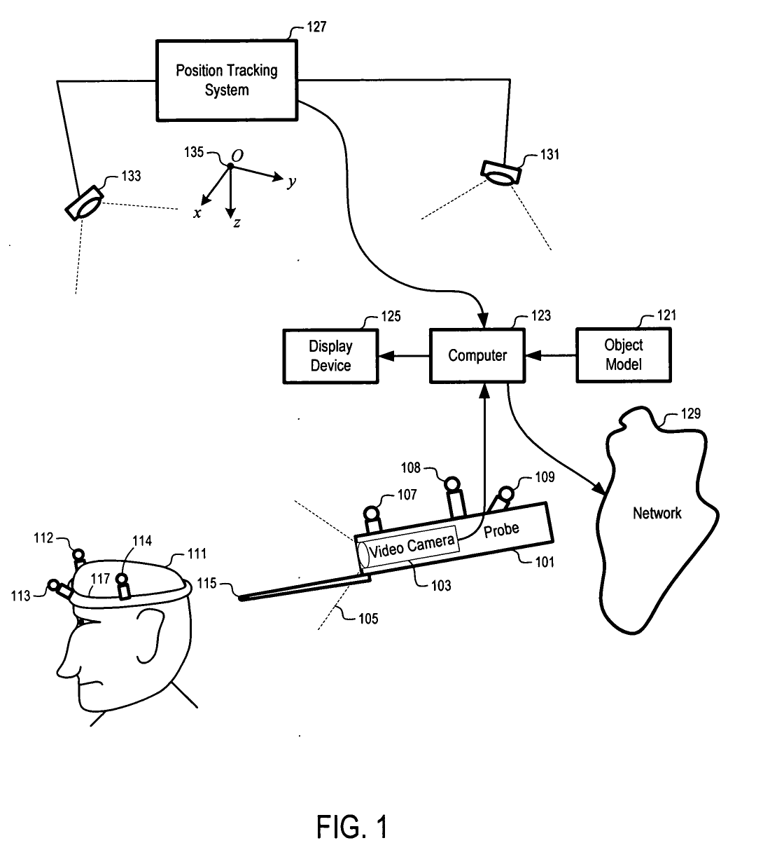

FIG. 1 illustrates an image guided surgery system according to one embodiment. In FIG. 1, a computer (123) is used to generate a virtual image of a view, according to a viewpoint of the video camera (103), to enhance the display of the reality based image captured by the video camera (103). The reality image and the virtual image are mixed in real time for display on the display device (125) (e.g., a monitor, or other display devices). The computer (123) generates the virtual image based on the object model (121) which is typically generated from scan images of the patient and defined before the image guided procedure (e.g., a neurosurgical procedure). The object model (121) can include diagnose information, surgical plan, and/or segmented anatomical features that are captured in the scanned 3D image data.

In FIG. 1, a video camera (103) is mounted on a probe (101) such that a portion of the probe, including the tip (115), is in the field of view (105) of the camera. In one embodiment, the video camera (103) has a known position and orientation with respect to the probe (101) such that the position and orientation of the video camera (103) can be determined from the position and the orientation of the probe (101).

Alternatively, the probe (101) may not include a video camera; and a representation of the probe is overlaid on the scanned image of the patient based on the current spatial relation between the patient and the probe.

In general, images used in navigation, obtained pre-operatively or intraoperatively from imaging devices such as ultrasonography, MRI, X-ray, etc., can be the images of internal anatomies. To show a navigation instrument inside a body part of a patient, its position as tracked can be indicated in the images of the body part.

For example, the pre-operative images can be registered with the corresponding body part. In the registration process, the spatial relation between the pre-operative images and the patient in the tracking system is determined. Using the spatial relation determined in the registration process, the location of the navigation instrument as tracked by the tracking system can be spatially correlated with the corresponding locations in the pre-operative images. For example, a representation of the probe can be overlaid on the pre-operative images according to the relative position between the patient and the probe. Further, the system can determine the pose (position and orientation) of the video camera base on the tracked location of the probe. Thus, the images obtained from the video camera can be spatially correlated with the pre-operative images for the overlay of the video image with the pre-operative images.

Various registration techniques can be used to determine the spatial relation between the pre-operative images and the patient. For example, one registration technique maps the image data of a patient to the patient using a number of anatomical features (at least 3) on the body surface of the patient by matching their positions identified and located in the scan images and their corresponding positions on the patient as determined using a tracked probe. The registration accuracy can be further improved by mapping a surface of a body part of the patient generated from the imaging data to the surface data of the corresponding body part generated on the operating table. Some example details on registration can be found in U.S. patent application Ser. No. 10/480,715, filed Jul. 21, 2004 and entitled “Guide System and a Probe Therefor,” the disclosure of which is hereby incorporated herein by reference.

In FIG. 1, the position tracking system (127) uses two tracking cameras (131 and 133) to capture the scene for position tracking. A frame (117) with a number of feature points is attached rigidly to a body part of the patient (111). The feature points can be fiducial points marked with markers or tracking balls (112-114), or Light Emitting Diode (LED). In one embodiment, the feature points are tracked by the tracking system (127). In a registration process, the spatial relation between the set of feature points and the pre-operative images is determined. Thus, even if the patient is moved during the surgery, the spatial relation between the pre-operative images which represent the patient and positions determined by the tracking system can be dynamically determined, using the tracked location of the feature points and the spatial relation between the set of feature points and the pre-operative images.

In FIG. 1, the probe (101) has feature points (107, 108 and 109) (e.g., tracking balls). The image of the feature points (107, 108 and 109) in images captured by the tracking cameras (131 and 133) can be automatically identified using the position tracking system (127). Based on the positions of the feature points (107, 108 and 109) of the probe (101) in the video images of the tracking cameras (131 and 133), the position tracking system (127) can compute the position and orientation of the probe (101) in the coordinate system (135) of the position tracking system (127).

In one embodiment, the location of the frame (117) is determined based on the tracked positions of the feature points (112-113); and the location of the tip (115) of the probe is determined based on the tracked positions of the feature points (107, 108 and 109). When the user signals (e.g., using a foot switch) that the probe tip is touching an anatomical feature (or a fiducial point) corresponding to an identified feature in the pre-operative images, the system correlates the location of the reference frame, the position of the tip of the probe, and the position of the identified feature in the pre-operative images. Thus, the position of the tip of the probe can be expressed relative to the reference frame. Three or more sets of such correlation data can be used to determine a transformation that maps between the positions as determined in the pre-operative images and positions as determined relative to the reference frame.

In one embodiment, registration data representing the spatial relation between the positions as determined in the pre-operative images and positions as determined relative to the reference frame is stored after the registration. The registration data is stored with identification information of the patient and the pre-operative images. When a registration process is initiated, such previously generated registration data is searched for the patient and the pre-operative images. If it is determined that the previous recorded registration data is found and valid, the registration data can be loaded into the computer process to eliminate the need to repeat the registration operations of touching the anatomical features with the probe tips.

Using the registration data, the image data of a patient, including the various objects associated with the surgical plan which are in the same coordinate systems as the image data, can be mapped to the patient on the operating table.

Although FIG. 1 illustrates an example of using tracking cameras in the position tracking system, other types of position tracking systems can also be used. For example, the position tracking system can determine a position based on the delay in the propagation of a signal, such as a radio signal, an ultrasound signal, or a laser beam. A number of transmitters and/or receivers can be used to determine the propagation delays to a set of points to track the position of a transmitter (or a receiver). Alternatively, or in combination, for example, the position tracking system can determine a position based on the positions of components of a supporting structure that can be used to support the probe.

Image based guidance can also be provided based on the real time position and orientation relation between the patient (111) and the probe (101) and the object model (121). For example, based on the known geometric relation between the viewpoint and the probe (101), the computer can generate a representation of the probe (e.g., using a 3D model of the probe) to show the relative position of the probe with respect to the object.

For example, the computer (123) can generate a 3D model of the real time scene having the probe (101) and the patient (111), using the real time determined position and orientation relation between the patient (111) and the probe (101), a 3D model of the patient (111) generated based on the pre-operative image, a model of the probe (101) and the registration data. With the 3D model of the scene, the computer (123) can generate a stereoscopic view of the 3D model of the real time scene for any pairs of viewpoints specified by the user. Thus, the pose of the virtual observer with the pair of viewpoints associated with the eyes of the virtual observer can have a pre-determined geometric relation with the probe (101), or be specified by the user in real time during the image guided procedure.

In one embodiment, the object model (121) can be prepared based on scanned images prior to the performance of a surgical operation. For example, after the patient is scanned, such as by CT and/or MRI scanners, the scanned images can be used in a virtual reality (VR) environment, such as a Dextroscope for planning. Detailed information on Dextroscope can be found in “Planning Simulation of Neurosurgery in a Virtual Reality Environment” by Kockro, et al. in Neurosurgery Journal, Vol. 46, No. 1, pp. 118-137, September 2000, and “Multimodal Volume-based Tumor Neurosurgery Planning in the Virtual Workbench,” by Serra, et al., in Proceedings of the First International Conference on Medical Image Computing and Computer-Assisted Intervention (MICCAI), Massachusetts, Institute of Technology, Cambridge Mass., USA, Oct. 11-13, 1998, pp. 1007-1016. The disclosures of these publications are incorporated herein by reference. Using Dextroscope, scanned images from different imaging modalities can be co-registered and displayed as a multimodal stereoscopic object. During the planning session, relevant surgical structures can be identified and isolated from scanned images. Additionally, landmarks and surgical paths can be marked. The positions of anatomical features in the images can also be identified. The identified positions of the anatomical features can be subsequently used in the registration process for correlating with the corresponding positions on the patient.

In some embodiments, no video camera is mounted in the probe. The video camera can be a separate device which can be tracked separately. For example, the video camera can be part of a microscope. For example, the video camera can be mounted on a head mounted display device to capture the images as seen by the eyes through the head mounted display device. For example, the video camera can be integrated with an endoscopic unit.

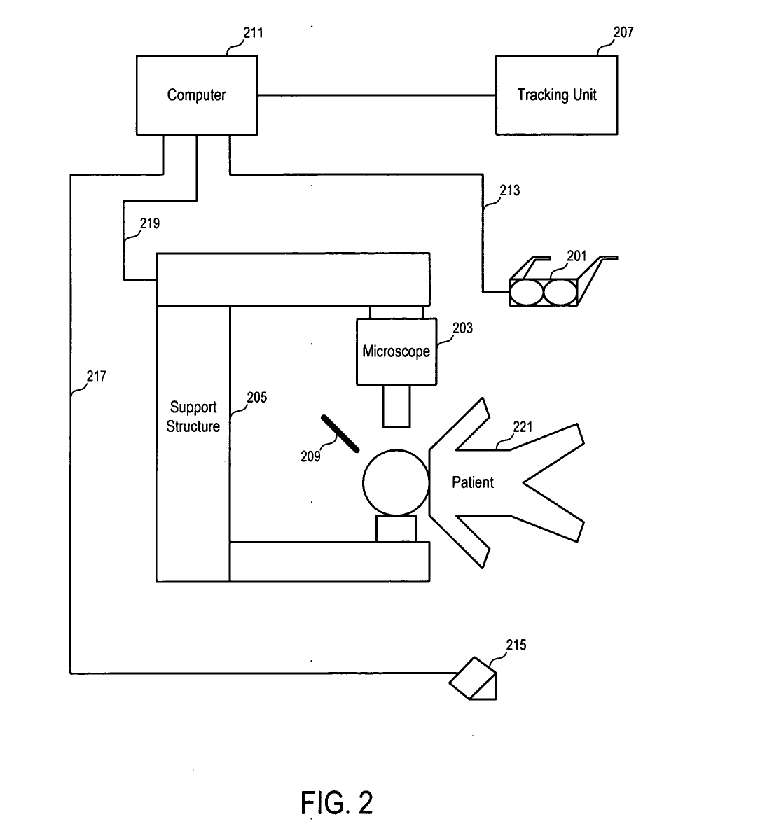

FIG. 2 illustrates another image guided surgery system according to one embodiment. The system includes a stereo LCD head mounted display (HMD) (201) (for example, a SONY LDI 100). The HMD (201) can be worn by a user, or alternatively, it can be mounted on and connected to an operating microscope (203) supported on a structure (205). In one embodiment, a support structure allows the LCD display (201) to be mounted on top of the binocular during microscopic surgery.

In one embodiment, the HMD (201) is partially transparent to allow the overlay of the image displayed on the HMD (201) onto the scene that is seen through the HMD (201). Alternatively, the HMD (201) is not transparent; and a video image of the scene is captured and overlaid with graphics and/or images that are generated based on the pre-operative images.

In FIG. 2, the system further includes an optical tracking unit (207) which tracks the locations of a probe (209), the HMD (201), and/or the microscope (203). For example, the location of the HMD (201) can be tracked to determine the viewing direction of the HMD (201) and generate the image for display in the HMD (201) according to the viewing direction of the HMD (201). For example, the location of the probe (209) can be used to present a representation of the tip of the probe on the image displayed on HMD (201). For example, the location and the setting of the microscope (203) can be used in generating the image for display in the HMD (201) when the user views the patient via the microscope. In one embodiment, the location of the patient (221) is also tracked. Thus, even if the patient moves during the operation, the computer (211) can still overlay the information accurately.

In one embodiment, the tracking unit (207) operates by detecting three reflective spherical markers attached to an object. Alternatively, the tracking unit (207) operates by detecting the light from LEDs. By knowing and calibrating the shape of an object carrying the markers (such as pen-shaped probe (209)), the location of the object can be determined in the 3D space covered by the two cameras of the tracking system. To track the LCD display (201), three markers can be attached along its upper frontal edge (close to the forehead of the person wearing the display). The microscope (203) can also be tracked by reflective makers, which are mounted to a support structure attached to the microscope (3) in such a way that a free line of sight to the cameras of the tracking system is provided during most of the microscope movements. In one embodiment, the tracking unit (207) used in the system is available commercially, such as from Northern Digital, Polaris. Alternatively, other types of tracking units can also be used.

In FIG. 2, the system further includes a computer (211), which is capable of real time stereoscopic graphics rendering, and transmitting the computer-generated images to the HMD (201) via cable (213). The system further includes a footswitch (215), which transmits signals to the computer (211) via cable (217). For example, during the registration process, a user can activate the footswitch to indicate to the computer that the probe tip is touching a fiducial point on the patient, at which moment the position of the probe tip represents the position of the fiducial point on the patient.

In one embodiment, the settings of the microscope (203) are transmitted (as discussed below) to the computer (211) via cable (219). The tracking unit (207) and the microscope (203) communicate with the computer (211) via its serial port in one embodiment. The footswitch (215) is connected to another computer port for interaction with the computer during the surgical procedure.

In one example of neurosurgery, the head of the patient (221) is registered to the volumetric preoperative data with the aid of markers (fiducials) on the patient's skin or disposed elsewhere on or in the patient. For example, the fiducials can be glued to the skin before the imaging procedure and remain on the skin until the surgery starts. In some embodiments, six or more fiducials are used. During the pre-operative planning phase, the positions of the markers in the images are identified and marked. In the operating theatre, a probe tracked by the tracking system is used to point to the fiducials in the real world (on the skin) that correspond to those marked on the images. The 3D data is then registered to the patient. In one embodiment, the registration procedure yields a transformation matrix which can be used to map the positions as tracked in the real world to the corresponding positions in the images.

In one embodiment, after completing the image-to-patient registration procedure, the surgeon can wear the HMD (201) and look at the patient (221) through the semi-transparent screen of the display (201) where the stereoscopic reconstruction of the segmented imaging data can be displayed. The surgeon perceives the 3D image data to be overlaid directly on the actual patient and, almost comparable to the ability of X-ray vision. The image of the 3D structures appearing “inside” the head can be viewed from different angles while the viewer is changing position.

In one embodiment, registering image data with a patient involves providing a reference frame with a fixed position relative to the patient and determining the position and orientation of the reference frame using a tracking device. The image data is then registered to the patient relative to the reference frame. For example, a transformation matrix that represents the spatial relation between the coordinate system of the image data and a coordinate system based on the reference frame can be determined during the registration process and recorded (e.g., in a file on a hard drive, or other types of memory, of the computer (123 or 211)). Alternatively, other types of registration data that can be used to derive the transformation matrix, such as the input data received during the registration, can be stored. When the program for the image guided surgery system is re-started for any reason, a module of the program automatically determine if the recorded registration data exists for the corresponding patient and image data. If valid registration data is available, the program can reuse the registration data and skip some of the registration operations.

In some embodiments, the module uses one or more rules to search and determine the validity of the registration data. For example, the name of the patient can be used to identify the patient. Alternatively, other types of identifications can be used to identify the patient. For example, a patient ID number can be used to identify the patient. Further, in some embodiment, the patient ID number can be obtained and/or derived from a Radio Frequency Identification (RFID) tag of the patient in an automated process.

In one embodiment, the module determines the validity of the registration data based on a number of rules. For example, the module can be configured to reject registration data that is older than pre-determined time period, such as 24 hours. In one embodiment, the module can further provide the user the options to choose between use the registration data or start a new registration process. The system can assign identifications to image data, such that the registration data is recorded in association with the identification of the image data.

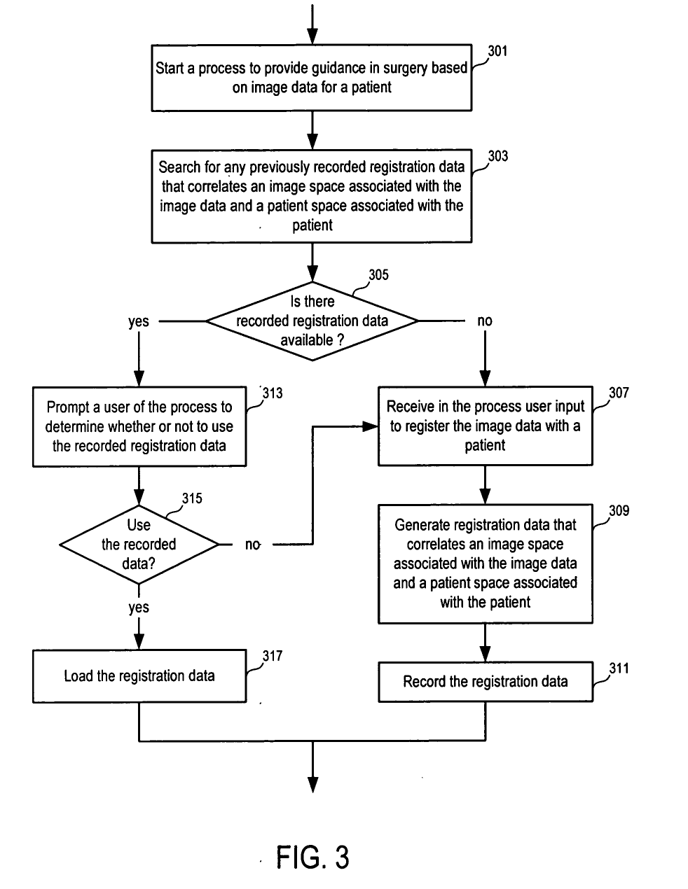

FIG. 3 illustrates a flow chart example of a method for image to patient registration according to one embodiment. In FIG. 3, a process is started (301) to provide guidance in surgery based on image data for a patient. The process searches (303) for any previously recorded registration data that correlates an image space associated with the image data and a patient space associated with the patient. The recorded registration data can be stored in a non-volatile memory, such as a hard drive, a flash memory or a floppy drive, or in types memory, or in a networked server. The recorded registration data can also be stored on volatile memory when the volatile memory is protected against application and/or system crash (e.g., via battery power).

If it is determined (305) that there is no recorded registration data available for the patient and the image data, user input is received (307) in the process to register the image data with a patient (e.g., foot switch signals indicating the probe tip is touching a fiducial). Registration data that correlates an image space associated with the image data and a patient space associated with the patient is generated (309) (e.g., based on the input from the tracking system) and recorded (311).

If it is determined (305) that there is recorded registration data available 305 for the patient and the image data, a user of the process is prompted (313) to determine whether or not to use the recorded registration data. If the use selects to use the recorded data (315), the registration data is loaded (317) for use in the image guided process; otherwise, registration operations (307-311) are performed.

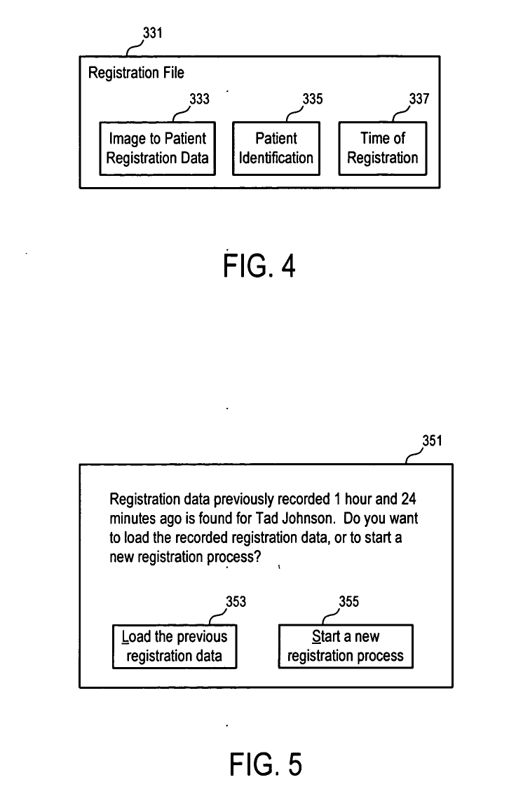

FIG. 4 illustrates a registration file in an image guided surgery system according to one embodiment. The registration file (331) can be implemented as a file in a file system located on a hard drive of the computer (11) of the image guided surgery system. The file can be named using the information that identifies the patient and/or the image data to store the image to patient registration data (333).

For example, the registration data can be stored in a file at a specified location in a file system, such as: patient_name/registration/registrationLog, where patient_name/registration is a path to the file, which is specific for a patient; and registrationLog is the file name for the registration data. Thus, searching for the registration data can be simplified as looking at a specified location (e.g., patient_name/registration) for a file with the specific name (e.g., registrationLog). If such a file exists, the data in the file is read to verify if it contains a valid registration data. If there is no valid registration data, the program runs without providing any notice to the user. Alternatively or in combination, the file can further include the patient identification (335) and/or time of registration (337). In one embodiment, an access time of the file (331) is used to identify the age of the registration data.

In one embodiment, the image to patient registration data (333) can be stored in a database (or a data store). The database can be implemented as a flat file, or a data storage space under the control of a database manager. The database can be on the same computer on which an image based guiding process runs, or on a server computer.

In one embodiment, the registration file (331) includes a number of suitable data or combinations of data, such as but not limited to registration data (image data, transformation matrix, etc.), patient name data, the time at which the registration data is entered into the file, and/or the like. When the computer for providing the image based guidance (e.g., 123, or 211) or software running on the computer breaks down or stops for any reason, a registration module can automatically search for the file (331) to determine whether the registration data (333) is available for reuse and for the elimination of some of the registration operations.

In one embodiment, a registration file (331) contains registration information for one patient. Different registrations files are generated for different patients and/or image data. The system deletes the out-of-date registration files to make room for new data. In another embodiment, a registration file (331) contains entries for different patients; and the system can query or parse the file to determine the availability of relevant registration data.

FIG. 5 illustrates a graphic user interface in an image guided surgery system according to one embodiment. In one embodiment, when an image guided process is started, a module of registration searches or queries the file (331). If valid registration data is found, the system can provide a user interface to allow the user to determine whether or not to use the recovered registration data. For example, the graphical user interface (351) presents the message “Registration data previously recorded 1 hour and 24 minutes ago is found for Tad Johnson. Do you want to load the recorded registration data, or to start a new registration process?” A user can select the button (353) to load the previous registration data, or the button (355) to start a registration process from scratch.

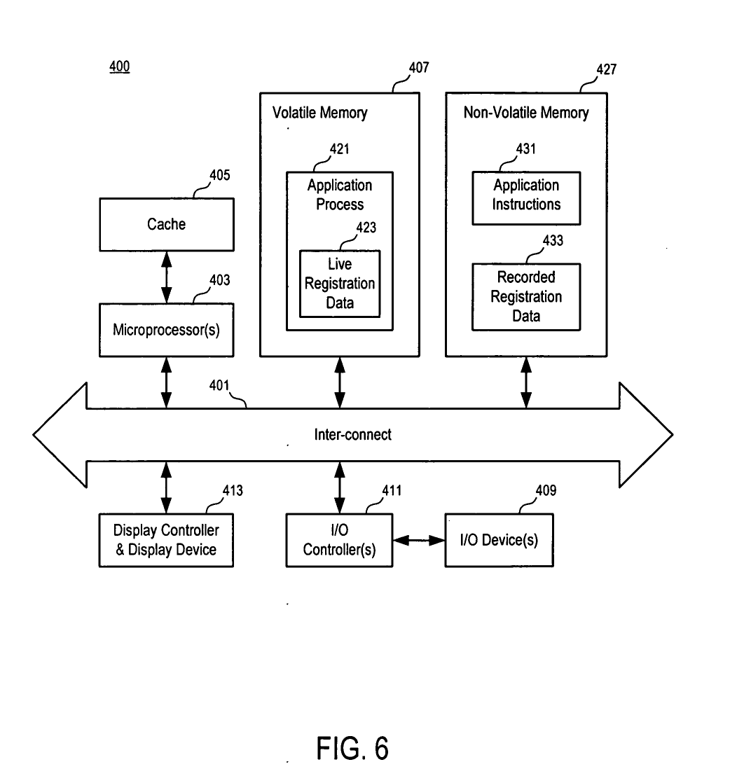

FIG. 6 shows a block diagram example of a data processing system for image guided surgery according to one embodiment. While FIG. 6 illustrates various components of a computer system, it is not intended to represent any particular architecture or manner of interconnecting the components. Other systems that have fewer or more components can also be used.

In FIG. 6, the computer system (400) is a form of a data processing system. The system (400) includes an inter-connect (401) (e.g., bus and system core logic), which interconnects a microprocessor(s) (403) and memory (407 and 427). The microprocessor (403) is coupled to cache memory (405), which can be implemented on a same chip as the microprocessor (403).

The inter-connect (401) interconnects the microprocessor(s) (403) and the volatile memory (407) and the non-volatile memory (427) together and also interconnects them to a display controller and display device (413) and to peripheral devices such as input/output (I/O) devices (409) through an input/output controller(s) (404). Typical I/O devices include mice, keyboards, modems, network interfaces, printers, scanners, video cameras and other devices.

The inter-connect (401) can include one or more buses connected to one another through various bridges, controllers and/or adapters. In one embodiment the I/O controller (404) includes a USB (Universal Serial Bus) adapter for controlling USB peripherals, and/or an IEEE-1394 bus adapter for controlling IEEE-1394 peripherals. The inter-connect (401) can include a network connection.

In one embodiment, the volatile memory (407) includes RAM (Random Access Memory), which typically loses data after the system is restarted. The non-volatile memory (427) includes ROM (Read Only Memory), and other types of memories, such as hard drive, flash memory, floppy disk, etc.

Volatile RAM is typically implemented as dynamic RAM (DRAM) which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after the main power is removed from the system. The non-volatile memory can also be a random access memory.

In one embodiment, the application instructions (431) are stored in the non-volatile memory (427) and loaded into the volatile memory (407) for execution as an application process (421). The application process (421) has live registration data (423) which is lost when the application process (421) is restarted. In one embodiment, a copy of the registration data is stored into the non-volatile memory (427), separate from the application process (421). When the application process (421) is started, it checks for the existence of recorded registration data (433) (e.g., at one or more pre-determined locations in the memory system). If suitable registration data is found, certain registration operations (e.g., 307-311 in FIG. 3) can be skipped.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

Various embodiments can be implemented using hardware, programs of instruction, or combinations of hardware and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects of the present disclosure can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope as set forth in the following claims. The specification and drawings are, accordingly, to be regarded in an illustrative sense rather than a restrictive sense.

What is claimed is:

1. A method, comprising:
receiving input data to register image data with a patient;
generating registration data based on the input data; and
recording the registration data.

2. The method of claim 1, further comprising:
searching for registration data prior to said receiving the input data.

3. The method of claim 2, wherein said receiving the input data is in response to a determination from said searching that no valid registration is available for the patient.

4. The method of claim 3, further comprising:
prompting a user to use a search result from said searching for registration data; and
wherein said receiving the input data is responsive to a user choice of not using the search result.

5. The method of claim 1, wherein the registration data includes a transformation matrix between a coordinate system of the image data and a coordinate system of a reference frame attached to the patient.

6. The method of claim 5, further comprising:
tracking a location of the reference frame via a location tracking system; and
determining a transformation between the coordinate system of the image data and a coordinate system of the location tracking system using the registration data.

7. The method of claim 1, wherein said recording the registration data comprises recording the registration data in a non-volatile memory.

8. The method of claim 7, wherein the non-volatile memory comprises a database.

9. The method of claim 7, wherein the non-volatile memory comprises a file on a file system.

10. The method of claim 9, wherein the file includes the registration data, identification information of the patient and a time of the registration data.

11. The method of claim 10, further comprising:
determining whether registration data found in said searching is valid based on one or more rules.

12. The method of claim 11, wherein the one or more rules comprises invaliding the registration data found in said searching if the registration data found in said searching is older than a pre-determine time period.

13. A method, comprising:
searching for registration data for registering image data with a patient in an image guided process;
response to a determination to perform registration after said searching, receiving input data to register the image data with the patient, generating registration data based on the input data, and recording the registration data; and
response to a determination to use the registration data found in said searching, using the registration data found in said searching in the image guided process.

14. The method of claim 13, further comprising:
receiving a user input to indicate whether to perform a registration or to use the registration data found in said searching.

15. The method of claim 13, further comprising:
validating the registration data found in said searching based on one or more rules.

16. The method of claim 15, wherein one of the one or more rules is based on an age of the registration data found in said searching.

17. The method of claim 13, wherein said searching comprises searching based on an identification of the patient.

18. A machine readable media embodying instructions, the instructions causing a machine to perform a method, the method comprising:
receiving input data to register image data with a patient;
generating registration data based on the input data; and
recording the registration data.

19. A machine readable media embodying instructions, the instructions causing a machine to perform a method, the method comprising:
searching for registration data for registering image data with a patient in an image guided process;
response to a determination to perform registration after said searching, receiving input data to register the image data with the patient, generating registration data based on the input data, and recording the registration data; and
response to a determination to use the registration data found in said searching, using the registration data found in said searching in the image guided process.

20. A data processing system, comprising:
means for generating registration data based on input data received to register image data with a patient; and
means for recording the registration data.

21. A data processing system, comprising:
memory; and
one or more processors coupled to the memory, the one or more processors to generating registration data based on input data received to register image data with a patient and to record the registration data in the memory.

22. The data processing system, further comprising:
a position tracking system coupled to the one or more processors, the position tracking system to generate the input data to register the image data with the patient.
